(19) United States
(12) Patent Application Publication
(10) Pub. No.: US 2010/0227995 A1
(43) Pub. Date: Sep. 9, 2010

(54) PRODUCTION OF VINYL ACETATE - VINYL ESTER COPOLYMERS HAVING A LOW CONTENT OF HIGH-BOILING VINYL ESTERS

(75) Inventor: Thomas Kohler, Kastl (DE)

Correspondence Address: RATNERPRESTIA, P.O. BOX 980, VALLEY FORGE, PA, 19482, US

(73) Assignee: Wacker Chemie AG, Munich (DE)

(21) Appl. No.: 12/678,933

(22) PCT Filed: Sep. 9, 2008
(86) PCT No.: PCT/EP2008/061888

§ 371 Date: Mar. 18, 2010

(30) Foreign Application Priority Data
Sep. 19, 2007 (DE) 102007044788.6

(51) Int. Cl. C08F 220/10

(52) U.S. Cl. 526/328.5

(57) ABSTRACT

The invention relates to a method for the production of vinyl acetate-vinyl ester copolymers having a low content of high-boiling vinyl esters by the radically initiated polymerization of 4.9 to 95 wt.-% vinyl acetate, 4.9 to 95 wt.-% of one or more high-boiling vinyl esters, and optionally 0.1 to 40 wt.-% of one or more ethylenically unsaturated auxiliary monomers, characterized in that additionally 0.1 to 40 wt.-% of vinyl acetate is added at a conversion rate of the polymerization of 65 to 99.9%, wherein the amounts given in wt.-% each refer to the total weight of the monomers, and add up to 100 wt.-%.

### CROSS REFERENCE TO RELATED APPLICATIONS

This application is the National Phase filing of PCT application number EP/2008/061888, filed Sep. 9, 2008, and claims priority of German patent application number DE102007044788.6, filed Sep. 19, 2007, the entire disclosures of which applications are incorporated herein by reference.

### FIELD OF THE INVENTION

The invention relates to a process for producing vinyl acetate-vinyl ester copolymers having a low content of high-boiling vinyl esters, and also to the vinyl acetate-vinyl ester copolymers obtainable by the process and to the use thereof.

### BACKGROUND OF THE INVENTION

Vinyl acetate-vinyl ester copolymers in the form of solid resins may be synthesized by radically initiated copolymerization of vinyl acetate and vinyl esters by the bulk or solution polymerization process. However, in particular in the case of corresponding copolymerizations having a fraction of high-boiling vinyl esters of ≧20% by weight, based on the total weight of the monomers, vinyl acetate-vinyl ester-copolymers having high contents of unpolymerized high-boiling vinyl esters are obtained. However, in the use of vinyl acetate-vinyl ester copolymers such as, for example, as a component in coating compositions, this is a disadvantage, since the unpolymerized high-boiling vinyl esters can cause an impairment of the adhesion properties or surface defects (pinholes) of coatings, or can migrate to the surface of coatings, which leads to smeary surfaces. In addition, high-boiling vinyl esters are volatile organic compounds (VOCs) which can be released to the environment from application products and in this manner impair health and pollute the environment. According to the definition of the World Health Organization, VOCs have a boiling range from 60 to 250° C. at atmospheric pressure. VOCs include, e.g., compounds of the groups of alkanes, alkenes, aromatics, terpenes, halogenated hydrocarbons, esters, aldehydes or ketones. Examples of high-boiling volatile vinyl esters are vinyl laurate (b.p. 254° C./1013 hPa) or vinyl esters of α-branched carboxylic acids such as VeoVa9™ (b.p. 185-200° C./1013 hPa) or VeoVa10™ (b.p. 244-247° C./1013 hPa) (both trademarks of the Hexion company).

The content of unpolymerized monomers (residual monomers) in vinyl acetate-vinyl ester copolymers can be decreased, for example, by distilling off the residual monomers from the copolymers, as described, for example, in DE-A 102007015941. In DE-A 10215961, it is advised to carry out corresponding distillations (stripping), using entrainers, such as isopropanol or water. Alternatively, vinyl acetate-vinyl ester copolymers can be subjected to secondary polymerization, with addition of further amounts of initiator, as a result of which the content of residual monomers is decreased.

It is a disadvantage in this case that the secondary polymerization or stripping significantly lengthens the overall time (cycle time) for production of vinyl acetate-vinyl ester copolymers starting from the corresponding monomers and nevertheless, vinyl acetate-vinyl ester comonomers having contents of high-boiling residual monomers of significantly below 1000 ppm cannot be synthesized. The removal of residual monomers by means of distillation or stripping is made more difficult, or impossible, in particular when high-boiling monomers, such as, for example, high-boiling vinyl esters, are concerned. Also, for the removal of residual monomers by stripping, a certain volatility of the unpolymerized monomers is required. In particular in the production of vinyl acetate-vinyl ester copolymers on an industrial scale, sufficient removal of high-boiling residual monomers by means of distillation or stripping is not possible in an economic manner. Secondary polymerization is associated with the disadvantage that, as a side reaction, crosslinking or grafting of the vinyl acetate-vinyl ester copolymers occurs, as a result of which the properties of the products such as, for example, their viscosity, are impaired. Such side reactions occur, in particular, when a plurality of secondary polymerizations are carried out one after the other.

The object was therefore to provide processes for producing vinyl acetate-vinyl ester copolymers having a low content of high-boiling vinyl esters, in which the abovementioned disadvantages do not occur.

### SUMMARY OF THE INVENTION

The invention relates to processes for producing vinyl acetate-vinyl ester copolymers having a low content of high-boiling vinyl esters by radically initiated polymerization of

4.9 to 95% by weight vinyl acetate,
4.9 to 95% by weight of one or more high-boiling vinyl esters, and also, if appropriate,
0.1 to 40% by weight of one or more ethylenically unsaturated auxiliary monomers, which comprises adding additionally 0.1 to 40% by weight vinyl acetate at a conversion rate of the polymerization of 65 to 99.9%,
wherein the figures in % by weight in each case relate to the total weight of monomers and respectively total 100% by weight.

### DETAILED DESCRIPTION OF THE INVENTION

A low content of high-boiling vinyl esters means that the vinyl acetate-vinyl ester copolymers have a content of high-boiling vinyl esters of generally ≦1000 ppm, preferably ≦500 ppm, particularly preferably ≦200 ppm, very particularly preferably ≦100 ppm, and most preferably ≦50 ppm.

The high-boiling vinyl esters have, according to the invention, a boiling point of preferably ≧150° C. at 1013 hPa, particularly preferably ≧175° C. at 1013 hPa, most preferably ≧200° C. at 1013 hPa.

Preferred high-boiling vinyl esters are vinyl esters of linear monocarboxylic acids having 5 up to 20 carbon atoms or vinyl esters of alpha-branched monocarboxylic acids having 5 to 20 carbon atoms. Examples of preferred high-boiling vinyl esters are vinyl laurate, vinyl stearate, vinyl neodecanoate, VeoVa9™ and VeoVa10™ (both trademarks of the Hexion company). Particularly preferred high-boiling vinyl esters are vinyl laurate, VeoVa9™ and VeoVa10™.

The fraction of high-boiling vinyl ester units in the vinyl acetate-vinyl ester copolymers is preferably 20 to 80% by weight, particularly preferably 40 to 80% by weight, and most preferably 50 to 80% by weight, based on the total mass of the vinyl acetate-vinyl ester copolymers.

The fraction of vinyl acetate units in the vinyl acetate-vinyl ester copolymers is preferably 20 to 80% by weight, particularly preferably 20 to 60% by weight, and most preferably 20 to 50% by weight, based on the total mass of the vinyl acetate-vinyl ester copolymers.

Ethylenically unsaturated auxiliary monomers comprise vinyl acetate and vinyl esters of carboxylic acids having 1 to 15 carbon atoms different from the high-boiling vinyl esters. Preferred ethylenically unsaturated auxiliary monomers are vinyl propionate, vinyl butyrate, vinyl 2-ethylhexanoate, 1-methylvinyl acetate and vinyl pivalate.

Ethylenically unsaturated auxiliary monomers also comprise one or more monomers from the group consisting of acrylic esters and methacrylic esters of unbranched or branched alcohols having 1 to 15 carbon atoms, vinylaromatics and vinyl halides. Particularly preferred acrylic esters or methacrylic esters are methyl acrylate, methyl methacrylate, ethyl acrylate, ethyl methacrylate, propyl acrylate, propyl methacrylate, n-butyl acrylate, isobutyl acrylate and t-butyl acrylate, n-butyl methacrylate, isobutyl methacrylate and t-butyl methacrylate, 2-ethylhexyl acrylate, norbornyl acrylate, isobornyl acrylate, stearyl acrylate. The most preferred acrylic esters or methacrylic esters are methyl acrylate, methyl methacrylate, n-butyl acrylate, isobutyl acrylate and t-butyl acrylate, 2-ethylhexyl acrylate and isobornyl acrylate. Vinylaromatics which can be copolymerized are stearyl or vinyltoluene. Of the group of vinyl halides, customary use is made of vinyl chloride, vinylidene chloride or vinyl fluoride, preferably vinyl chloride.

Ethylenically unsaturated auxiliary monomers also comprise olefins and dienes such as, for example, ethene and propene; ethylenically unsaturated mono- and dicarboxylic acids or salts thereof such as, for example, acrylic acid, methacrylic acid, crotonic acid, fumaric acid and maleic acid; ethylenically unsaturated anhydrides such as, for example, maleic anhydride; mono- or diesters of fumaric acid or maleic acid such as, for example, ethyl or isopropyl esters thereof; ethylenically unsaturated epoxides such as, for example, glycidyl acrylate, glycidyl methacrylate (GMA) or allyl glycidyl ether; ethylenically unsaturated sulfonic acids or salts thereof such as, for example, vinylsulfonic acid, 2-acrylamido-2-methylpropane-sulfonic acid; ethylenically unsaturated alcohols such as, for example, 2-hydroxyethyl acrylate, hydroxypropyl acrylate, 2-hydroxyethyl methacrylate, hydroxypropyl methacrylate, or glycerol 1-allyl ether; ethylenically unsaturated primary, secondary or tertiary amines such as, for example, 2-dimethylaminoethyl methacrylate, 2-tert-butylaminoethyl methacrylate, allyl N-(2-amino-ethyl) carbamate hydrochloride, allyl N-(6-amino-hexyl) carbamate hydrochloride, allyl N-(3-aminopropyl) hydrochloride, allylamine or vinylpyridine; ethylenically unsaturated amides such as, for example, 3-dimethylaminopropylmethacrylamide, 3-trimethylammonium propyl methacrylamide chloride; phosphonic acids or salts thereof such as, for example, vinylphosphonic acid, SIPOMER PAN-100^{R} or SIPOMER-200^{R} (trademarks of the Rhodia company).

Preferred ethylenically unsaturated auxiliary monomers are also acrylic acid, crotonic acid, fumaric acid, maleic acid, glycidyl methacrylate (GMA), 2-hydroxy-ethyl acrylate, and hydroxypropyl acrylate.

The vinyl acetate-vinyl ester copolymers are produced by the bulk polymerization process, and preferably by the solution polymerization process. Suitable solvents are, for example, aldehydes, such as acetaldehyde, propionaldehyde and butyraldehyde; ketones, such as acetone or methyl ethyl ketone; esters, such as methyl acetate, ethyl acetate and butyl acetate, or monohydric aliphatic alcohols having 1 to 6 carbon atoms, preferably methanol, ethanol, propanol, isopropanol. Particular preference is given to ethyl acetate, methanol and isopropanol.

The polymerization is generally carried out under reflux conditions, generally at a polymerization temperature of 40° C. to 160° C. This can proceed at atmospheric pressure, superatmospheric pressure or reduced pressure. In the case of copolymerization of gaseous comonomers such as ethylene, higher pressures, generally 5 to 150 bar, can also be employed. If the reaction is carried out at atmospheric pressure, it is advantageous at the end of the reaction to apply a slight overpressure to the reaction system, preferably 0.5 to 3 bar, in order to be able to feed external energy to the system, in order thus to achieve a temperature as high as possible and a high conversion rate, and in order to arrange the distillation off of the residual monomer and the solvent as effectively as possible.

Initiators used are organic peroxides or azo compounds. Suitable compounds are, for example, diacyl peroxides such as dilauroyl peroxide, peroxo esters such as t-butyl peroxopivalate or t-butyl peroxo-2-ethylhexanoate, or peroxodicarbonates such as diethyl peroxodicarbonate. The amount of initiator is generally 0.01 to 5.0% by weight, based on the total weight of the monomers. The initiators can either be charged or else metered. In this case charging a part of the required amount of initiator and continually metering the remainder during the reaction has proven itself.

For production of the vinyl acetate-vinyl ester copolymers, a batch process can be employed, wherein all components of the polymerization batch apart from the vinyl acetate replenishment are charged in the reactor, or a semi-batch process is employed, wherein individual or a plurality of components are charged and the remainder is added, or a continuous polymerization is carried out, wherein the components are added during the polymerization. The dosages can be carried out if appropriate separately (in space and time).

For carrying out the process according to the invention, it is essential that at a conversion rate of the polymerization from 65 to 99.9%, that is to say when at least 65% by weight (lower limit) and a maximum of 99.9% (upper limit) of the amount of monomer added up to the respective time point is copolymerized, a fraction of vinyl acetate is replenished (vinyl acetate replenishment) which corresponds to 0.1 to 40% by weight of the total weight of the monomers used in total. The vinyl acetate replenishment is preferably performed at a lower limit of conversion rate of the polymerization of ≧70%, particularly preferably of ≧80%, very particularly preferably of ≧90%, and most preferably of ≧92%, and at an upper limit of preferably ≦99.5%, particularly preferably ≦99%, still more preferably ≦97%, and most preferably ≦95%. The vinyl acetate replenishment is preferably 1 to 20% by weight, particularly preferably 1 to 10% by weight, based on the total weight of the monomers used in total. The vinyl acetate replenishment can proceed discontinuously or continuously.

The polymerization is generally interrupted at a conversion rate of 95 to 99.9%, based on the total weight of the monomers used in total. The content of unpolymerized high-boiling vinyl esters in the polymerization product is at this time point preferably 10 to 10,000 ppm.

After termination of the polymerization, residual monomers and the solvent are removed by distillation. For this, the internal temperature can be increased to 100° C. to 200° C. and subsequently a vacuum can be applied.

For reduction of the content of unpolymerized high-boiling vinyl esters or other residual monomers in the vinyl acetate-vinyl ester copolymers, secondary polymerization can be carried out. For this, initiator, if appropriate dissolved in vinyl acetate, or in one or more ethylenically unsaturated auxiliary monomers or in one or more solvents is added and heated to 40° C. to 200° C. In this case the abovementioned initiators and the solvents mentioned for the solution polymerization are suitable. Preferably, the secondary polymerization is carried out in the presence of vinyl acetate. Subsequently, any solvents or residual monomers present are distilled off at 100° C. to 200° C., preferably in vacuum. Preferably, secondary polymerization is carried out 1 to 3 times. Particularly preferably, secondary polymerization is carried out once. The amount of vinyl acetate added if appropriate in the course of the secondary polymerization is not comprised in the vinyl acetate replenishment.

The content of unpolymerized high-boiling vinyl esters in the vinyl acetate-vinyl ester copolymers is, according to these measures, generally ≦1000 ppm, preferably ≦5 500 ppm, particularly preferably ≦200 ppm, and most preferably ≦50 ppm.

The content of residual monomers in the vinyl acetate-vinyl ester copolymers can be further decreased by stripping once or several times. For this, one or more entrainers are added to the vinyl acetate-vinyl ester copolymers, which entrainers are subsequently distilled off preferably at 100° C. to 200° C., preferably in vacuum. Preferred entrainers are isopropanol or water. As a result of the stripping, predominantly vinyl acetate or low-boiling residual monomers are distilled off. Stripping is preferably carried out up to 2 times or up to 3 times. However, no stripping is required to obtain vinyl acetate-vinyl ester copolymers having low contents of high-boiling vinyl esters by the process according to the invention.

The invention further relates to vinyl acetate-vinyl ester copolymers having a low content of high-boiling vinyl esters which is obtainable by radically initiated polymerization of

4.9 to 95% by weight vinyl acetate,
4.9 to 95% by weight of one or more high-boiling vinyl esters, and also, if appropriate,
0.1 to 40% by weight of one or more ethylenically unsaturated auxiliary monomers, which comprises adding additionally 0.1 to 40% by weight vinyl acetate at a conversion rate of the polymerization of 65 to 99.9%,
wherein the figures in % by weight in each case relate to the total weight of monomers and respectively total 100% by weight.

The vinyl acetate-vinyl ester copolymers are suitable, for example, for use as binders in paints, for production of adhesives, in particular of hot-sealable coatings, and also of laminating agents. Further fields of application are use as base materials for fabric finishes and chewing gum mixes and also as low-profile additives in the field of composite components. The vinyl acetate-vinyl ester copolymers can be used for this in solid form as solid resins or in the form of solutions in organic solvents.

The examples hereinafter serve for further explanation of the invention:

### Comparative Example 1 (C1)

In a stirred tank, 1.7 kg of isopropanol, 11 kg of vinyl acetate, 16 kg of vinyl laurate and 10 g of t-butyl peroxo-2-ethylhexanoate were charged and the polymerization was initiated by heating to 78° C. After initiation of the polymerization, the mixture was stirred for 360 minutes, during which the temperature was increased to 89° C. Subsequently the stirred tank was heated to 140° C. and solvent and also residual monomers were distilled off in vacuum. For the secondary polymerization, 30 g of di-t-butyl-peroxobutane dissolved in 0.2 kg of vinyl acetate were added and the mixture was stirred for 60 minutes at 140° C. Subsequently, the volatile components were distilled off in vacuum in the course of 2 hours. The total time of the secondary polymerization was 3 hours. For the removal of further traces of volatile organic compounds, 1 liter of water was added and subsequently distilled off in vacuum in the course of 2 hours. This step was repeated one further time (in total 2 stripping steps).

Draining off the resultant melt from the stirred tank into cartons led to a transparent solid resin having a glass transition temperature Tg of −21° C., a molecular weight Mw of 511 000 g/mol and a content of the high-boiling vinyl ester vinyl laurate of 5700 ppm.

### Comparative Example 2 (C2)

In a stirred tank, 1.7 kg of isopropanol, 11 kg of vinyl acetate, 16 kg of vinyl laurate and 10 g of t-butyl peroxo-2-ethylhexanoate were charged and the polymerization was initiated by heating to 78° C. After initiation of the polymerization, the mixture was stirred for 360 minutes, during which the temperature was increased to 89° C. Subsequently, the stirred tank was heated to 140° C. and solvent and residual monomer were distilled off in vacuum. For the secondary polymerization, 30 g of di-t-butylperoxybutane dissolved in 0.2 kg of vinyl acetate were added and the mixture was stirred for 60 minutes at 140° C.

Subsequently, the volatile components were distilled off in vacuum in the course of 2 hours. The total time of a secondary polymerization was 3 hours. The secondary polymerization was carried out in total 3 times. For the removal of further traces of volatile organic compounds, 1 liter of water was added and subsequently distilled off in vacuum in the course of 2 hours. This step was repeated once more (in total 2 stripping steps).

Draining off the resultant melt from the stirred tank into cartons led to a transparent solid resin having a glass transition temperature Tg of −18° C., a molecular weight Mw of 480 000 g/mol and a content of the high-boiling vinyl ester vinyl laurate of 2150 ppm.

### Example 3 (E3)

In a stirred tank, 1.7 kg of isopropanol, 9 kg of vinyl acetate, 16 kg of vinyl laurate and 10 g of t-butyl peroxo-2-ethylhexanoate were charged and the polymerization was initiated by heating to 78° C. 240 minutes after initiation, at a conversion rate of the monomers of 80%, 2 kg of vinyl acetate were replenished in the course of 5 minutes. The mixture was stirred for 120 minutes, during which the temperature was increased to 92° C. Subsequently, the mixture was heated to 140° C. and solvent and residual monomer were distilled off in vacuum. For the secondary polymerization, 30 g of di-t-butylperoxybutane distilled in 0.2 kg of vinyl acetate were added and the mixture was stirred for 60 minutes at 140° C. Subsequently, the volatile components were distilled off under vacuum in the course of 2 hours. The secondary polymerization was repeated a further 2 times. For removal of further traces of volatile organic compounds, 1 liter of water was added and distilled off in vacuum in the course of 2 hours. This step was repeated once more (in total 2 stripping steps).

Draining off the resultant melt from the stirred tank into cartons led to a transparent solid resin having a glass transition temperature Tg of −18° C., a molecular weight Mw of 481 000 g/mol and a content of the high-boiling vinyl ester vinyl laurate of 26 ppm.

### Example 4 (E4)

In a stirred tank, 1.7 kg of isopropanol, 9 kg of vinyl acetate, 16 kg of vinyl laurate and 10 g of t-butyl peroxo-2-ethylhexanoate were charged and the polymerization was initiated by heating to 78° C. 240 minutes after initiation, at a conversion rate of the monomers of 80%, 2 kg of vinyl acetate were replenished in the course of 5 minutes. The mixture was stirred for 120 minutes, during which the temperature was increased to 92° C. Subsequently, the mixture was heated to 140° C. and solvent and residual monomer were distilled off in vacuum. For the secondary polymerization, 30 g of di-t-butylperoxybutane distilled in 0.2 kg of vinyl acetate were added and the mixture was stirred for 60 minutes at 140° C. Subsequently, the volatile components were distilled off under vacuum in the course of 2 hours. The removal of further traces of volatile organic compounds by stripping was omitted.

Draining off the resultant melt from the stirred tank into cartons led to a transparent solid resin having a glass transition temperature Tg of −16° C., a molecular weight Mw of 424 000 g/mol and a content of the high-boiling vinyl ester vinyl laurate of 142 ppm.

Example 6 (E6), example 8 (E8), examples 10 to 12 (E10 to E12) were carried out in a similar manner to examples 3 and 4, and comparative example 5 (C5), comparative example 7 (C7), comparative example 9 (C9) and also the comparative examples 13 to 15 (C13 to C15) were carried out in a similar manner to comparative example 1 and 2, wherein the monomers, their fraction of the respective monomer composition and also further process parameters were used in accordance with the figures given in table 1. In the case of the polymerizations described by table 1, in each case as much vinyl acetate was used so that the amounts of high-boiling vinyl esters and vinyl acetate in total add up to 100% by weight.

TABLE 1
Process parameters and also residual monomer contents
of the vinyl acetate-vinyl ester copolymers of
the examples and comparative examples:

| | High-boiling | VAc^{a)} - | | | Residual |
|---|---|---|---|---|---|
| | vinyl ester^{a)} | replenishment | | Stripping | monomer |
| | ([% by | [% by | | steps | content^{a),c)} |
| | weight]) | weight] | NP^{b)} | [number] | [ppm] |
| C1 | VL (60) | — | 1 | 2 | 5.700 |
| C2 | VL (60) | — | 3 | 2 | 2.150 |
| E3 | VL (60) | 7.5 | 3 | 2 | 26 |
| E4 | VL (60) | 7.5 | 1 | — | 142 |
| C5 | VL (40) | — | 3 | 2 | 950 |
| E6 | VL (40) | 7.5 | 1 | — | 85 |
| C7 | VL (20) | — | 1 | 2 | 850 |
| E8 | VL (20) | 7.5 | 1 | — | 43 |
| C9 | VV9 (40) | — | 2 | — | 1.150 |
| E10 | VV9 (40) | 7.5 | 1 | — | 77 |
| E11 | VV9 (40) | 7.5 | 3 | 2 | 15 |
| E12 | VV10 (40) | 7.5 | 1 | — | 103 |
| C13 | VL (60) | — | — | — | 19.200 |
| C14 | VL (60) | — | — | 1 | 14.300 |
| C15 | VL (60) | — | 1 | — | 11.900 |

^{a)}VAc = vinyl acetate, VL = vinyl laurate, VV9 = VeoVa9 ™, VV10 = VeoVa10 ™
^{b)}NP: number of secondary polymerizations
^{c)}the residual monomer content is based here on the content of the respective high-boiling vinyl ester in the vinyl acetate-vinyl ester copolymer

Comparative examples 13 to 15 verify that for decreasing the content of unpolymerized high-boiling vinyl esters in the vinyl acetate-vinyl ester copolymers, carrying out a secondary polymerization is more effective than stripping.

It follows from comparative example 1 (C1, table 1) that the content of high-boiling vinyl ester in the vinyl acetate-vinyl ester copolymer can only be decreased to 5700 ppm, despite secondary polymerization and stripping 2 times. Although increasing the number of secondary polymerizations from 1 (C1, table 1) to 3 (C2, table 1) led to a lower content of vinyl laurate, it was still unacceptably high and it is known from experience that it cannot be decreased to values below 500 ppm by further process steps (secondary polymerization, stripping). Therefore, vinyl acetate-vinyl ester copolymers having low contents of high-boiling vinyl esters cannot be synthesized in a conventional manner.

Furthermore, the cycle time was significantly increased by the time-consuming repeated secondary polymerization and repeated stripping in C2. In C2, the time consumption for decreasing the content of high-boiling vinyl esters was even higher than the time consumption for carrying out the polymerization. However, this is unacceptable for an effective and inexpensive production of vinyl acetate-vinyl ester copolymers and leads to high production costs.

When the process according to the invention is used, in contrast, the content of high-boiling vinyl esters can be decreased by orders of magnitude to, for example, 26 ppm (example 3).

Even when the process according to the invention was carried out without stripping and with only one secondary polymerization (example 4), compared with comparative examples 1 and 2, only a very low content of vinyl laurate remained in the vinyl acetate-vinyl ester copolymer—and this was achieved in addition at a considerably shortened cycle time.

From comparative example 5 and example 6, and comparative example 7 and example 8, respectively, it can be seen that also in the production of vinyl acetate-vinyl ester copolymers having lower contents of vinyl laurate (40% by weight or 20% by weight vinyl laurate, respectively, based on the total weight of the polymers) a great decrease of the content of unpolymerized vinyl laurate in the vinyl acetate-vinyl ester copolymer can be achieved by the process according to the invention, although in the procedure according to the invention (examples 6 and 8), time-consuming stripping was omitted. However, the effect according to the invention is particularly dramatic in the production of vinyl acetate-vinyl ester copolymers having high contents of high-boiling vinyl esters (examples 3 and 4, and comparative examples 1 and 2).

Examples 10 to 12 and comparative example 9 confirm that the statements made above for vinyl laurate also apply in the case of use of the vinyl esters VeoVa9™ and VeoVa10™ which are low-boiling compared with vinyl laurate.

1. A process for producing a vinyl acetate-vinyl ester copolymer having a low content of high-boiling vinyl esters with a boiling point of ≧150° C. at 1013 hPa by radically initiated polymerization of
4.9 to 95% by weight vinyl acetate,
4.9 to 95% by weight of one or more high-boiling vinyl esters, and optionally,
0.1 to 40% by weight of one or more ethylenically unsaturated auxiliary monomers, wherein additionally 0.1 to 40% by weight vinyl acetate is added at a conversion rate of the polymerization of 65 to 99.9%, and the content of unpolymerized high-boiling vinyl esters in the copolymer is decreased by a secondary polymerization step comprising adding initiator and heating to 40° C. to 200° C.,
wherein the figures in % by weight in each case relate to the total weight of monomers and respectively total 100% by weight.

2. The process as claimed in claim 1, wherein the content of high-boiling vinyl esters is ≦500 ppm.

3. The process as claimed in claim 1, wherein the high-boiling vinyl esters have a boiling point of ≧150° C. at 1013 hPa.

4. The process as claimed in claim 1, wherein the high-boiling vinyl esters are vinyl esters of linear monocarboxylic acids having up to 20 carbon atoms and/or vinyl esters of alpha-branched monocarboxylic acids having 5 to 20 carbon atoms.

5. The process as claimed in claim 1, wherein the high-boiling vinyl esters are one or more monomers selected from the group consisting of vinyl laurate, vinyl stearate, vinyl neodecanoate, VeoVa9™ and VeoVa10™.

6. The process as claimed in claim 1, wherein the content of residual monomers in the vinyl acetate-vinyl ester copolymer is decreased by distillation or stripping.

7-8. (canceled)

9. A paint or laminating agent comprising the vinyl acetate-vinyl ester copolymer produced by the process of claim 1.

10. A low-profile additive or a base material for fabric finishes or chewing gum mixes comprising the vinyl acetate-vinyl ester copolymer produced by the process of claim 1.

11. The process of claim 1, wherein the initiator in the secondary polymerization step is dissolved in vinyl acetate or in one or more ethylenically unsaturated auxiliary monomers or in one or more solvents, or a combination of any of these.

12. The process of claim 1, wherein the initiator in the secondary polymerization step is dissolved in vinyl acetate and optionally a solvent.
